(19) United States
(12) Patent Application Publication
(10) Pub. No.: US 2012/0162422 A1
(43) Pub. Date: Jun. 28, 2012

(54) Fuel Dispenser System and Method Utilizing Vehicle Presence Detector

(76) Inventor: Michael D. Lester, High Point, NC (US)

(21) Appl. No.: 12/975,627

(22) Filed: Dec. 22, 2010

(51) Int. Cl. H04N 7/18; G08G 1/054

(52) U.S. Cl. 348/148; 340/937; 348/E07.085

(57) ABSTRACT

A system and method for activating and deactivating components of a fueling environment based on data transmitted by a sensor, such as a rangefinder or light curtain, configured to monitor an area adjacent to each fuel dispenser. The system and method also instruct the environment's components to perform other tasks based on data transmitted by the sensor.

### FIELD OF THE INVENTION

The present invention relates to fueling environments. More particularly the present invention relates to a fueling environment utilizing fuel dispensers equipped with vehicle presence detectors.

### BACKGROUND OF THE INVENTION

Some customers dispense gasoline and leave without paying for the dispensed fuel, which is commonly referred to as a “drive-off.” It is difficult for fuel station attendants to monitor the dispensers in order to prevent drive-offs, especially during peak operating hours. Additionally, certain fueling environment components, such as liquid crystal displays incorporated into fuel dispensers, remain in a powered-on, ready state when not in use. As a result, the useful life of such components is reduced, and unnecessary energy is consumed.

### SUMMARY OF THE INVENTION

The present invention recognizes and addresses the foregoing considerations, and others, of prior art construction and methods.

According to one aspect, the present invention provides a retail environment comprising a retail device and a sensor. The retail device comprises a processing device and a user interface including at least one component operatively connected to the processing device. The sensor is operatively connected to the processing device and is configured to detect a presence of an object located adjacent the retail device and transmit data to the processing device representative of the detection. The processing device is configured to activate the at least one component based on data received from the sensor.

Another aspect of the present invention provides a retail environment that includes at least one retail device. The retail environment comprises a processing device, a surveillance system operatively connected to the processing device, and a sensor operatively connected to the processing device. The sensor is configured to detect the presence of an object located adjacent the retail device and transmit data to the processing device representative of the detection. The processing device is configured to transmit data to the surveillance system corresponding to the presence based on data received from the sensor.

Yet a further aspect of the present invention provides a method for activating components of a retail environment, which includes a retail device and a sensor. The sensor is configured to detect the presence of an object occupying at least a portion of an area adjacent the retail device. The method comprises the steps of receiving data from the sensor indicating the presence of the object and activating a component based on the data.

The accompanying drawings, which are incorporated in and constitute a part of this specification, illustrate one or more embodiments of the present invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a perspective view of a fueling environment in accordance with an embodiment of the present invention;

FIGS. 2A and 2B are perspective views of fuel dispensers that may be used in the fueling environment of FIG. 1 in accordance with various embodiments of the present invention;

FIG. 3 is a perspective view of a fueling environment in accordance with an embodiment of the present invention; and

FIG. 4 is a flowchart of a process utilizing the information provided by sensors of a fueling environment, such as those illustrated in FIGS. 1 and 3, and of a fuel dispenser, such as those illustrated in FIGS. 2A and 2B, in accordance with an embodiment of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The present invention is related to a retail environment comprising a retail device, such as a retail fueling station comprising at least one fuel dispenser. Examples of retail fueling environments, fuel dispensers, and user interfaces for the dispensers are provided in U.S. Pat. Nos. 6,453,204 (entitled “Fuel Dispensing System”), 5,956,259 (entitled “Intelligent Fueling”), 5,734,851 (entitled “Multimedia Video/Graphics in Fuel Dispensers”), 6,052,629 (entitled “Internet Capable Browser Dispenser Architecture”), 5,689,071 (entitled “Wide Range, High Accuracy Flow Meter”), 6,935,191 (entitled “Fuel Dispenser Fuel Flow Meter Device, System and Method”), and 7,289,877 (entitled “Fuel Dispensing System for Cash Customers”) and in U.S. patent application Ser. Nos. 12/191,081 (entitled “Fuel Dispenser” and filed on Aug. 13, 2008), 12/689,983 (entitled “Payment Processing System for Use in a Retail Environment Having Segmented Architecture” and filed on Jan. 19, 2010), and 12/695,692 (entitled “Virtual PIN Pad for Fuel Payment Systems” and filed on Jan. 28, 2010), the entire disclosure of each of which is hereby incorporated by reference as if set forth verbatim herein for all purposes.

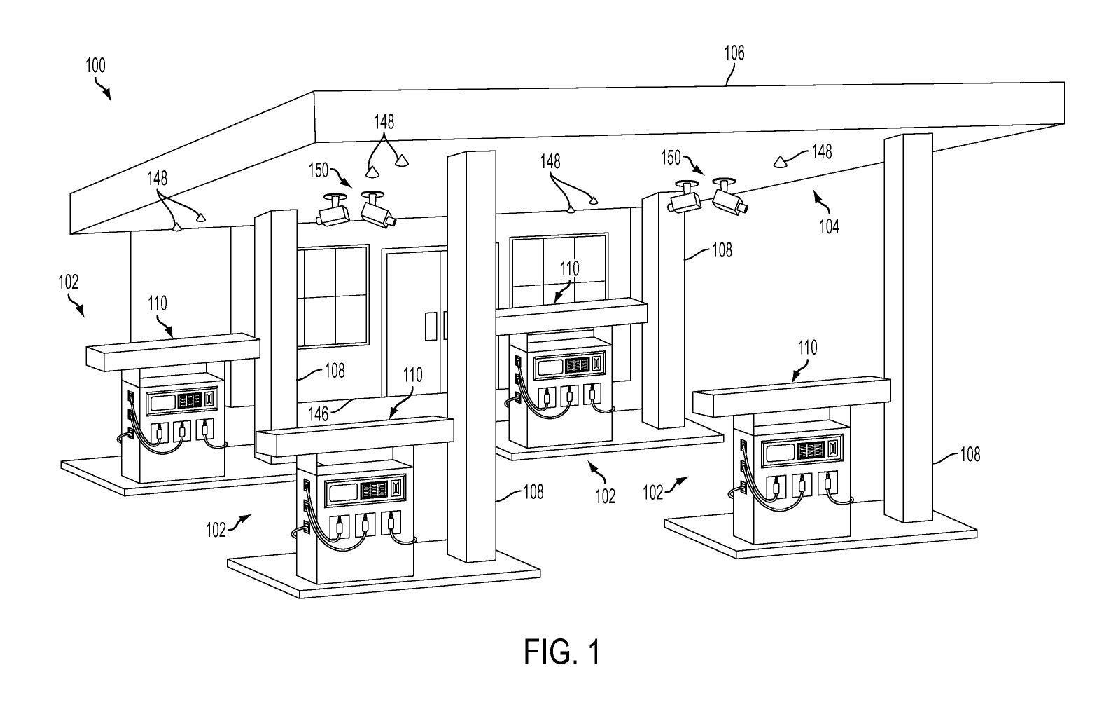

The ensuing description is provided with reference to several embodiments wherein the retail environment is a retail fueling environment or station. In these embodiments, the retail device is described as a fuel dispenser. It should be understood, however, that the present invention is applicable to and within retail environments comprising various retail devices without departing from the scope of the present invention. FIG. 1 illustrates a fueling environment 100 comprising a plurality of fueling islands 102 covered by a canopy system 104. Canopy system 104 comprises a canopy cover 106 supported by one or more canopy supports 108. Each fueling island 102 includes one or more fuel dispensers 110.

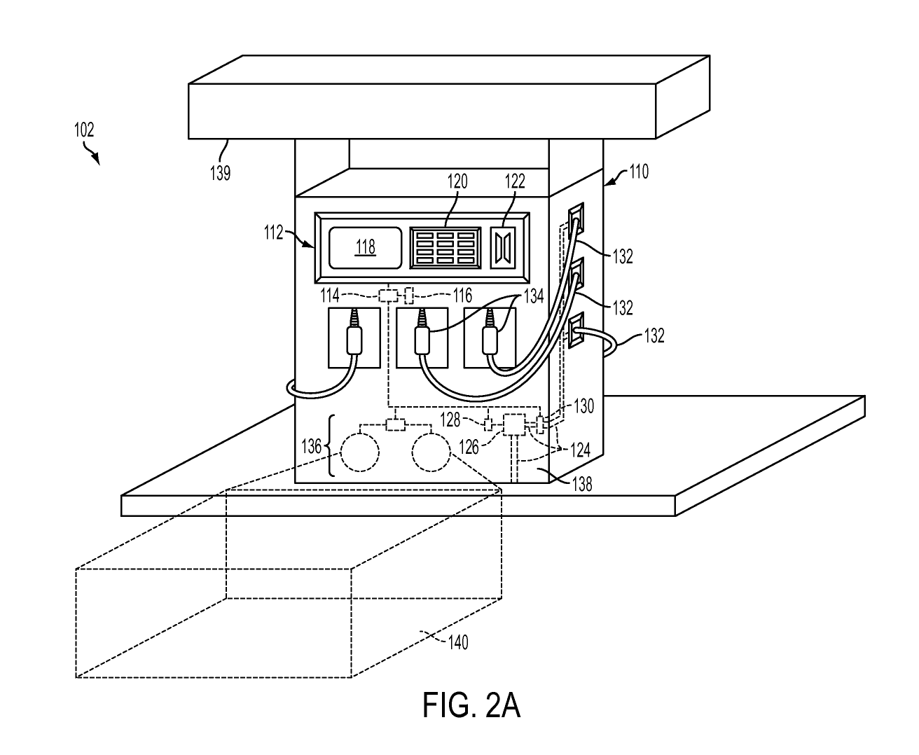

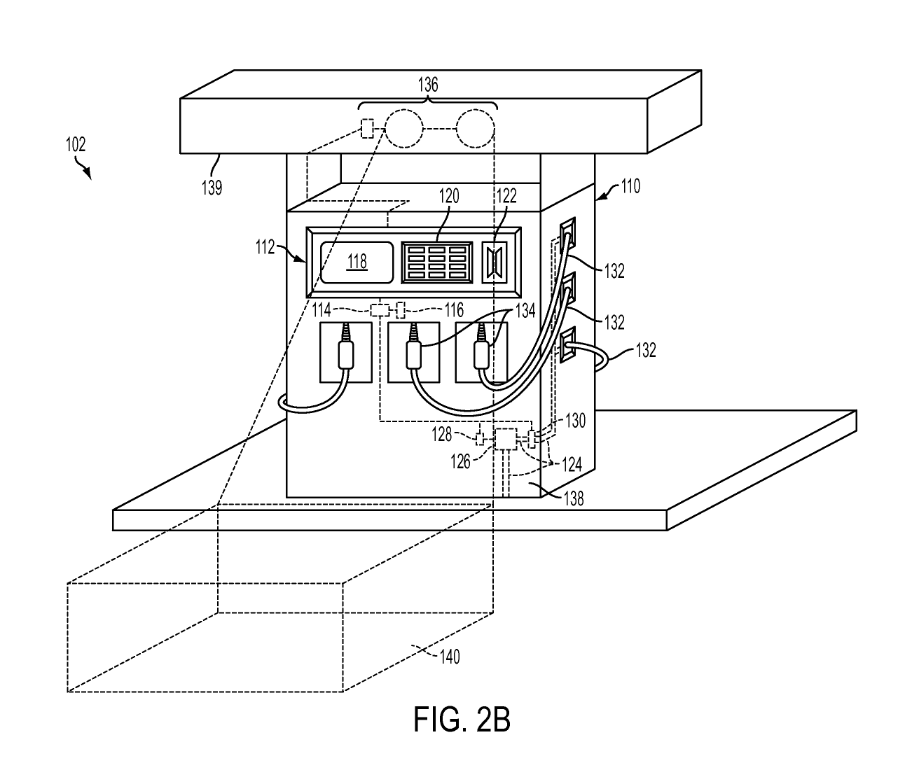

FIG. 2A is a perspective view of one of fuel dispensers 110, which comprises a user interface 112, a processing device 114, and memory 116. User interface 112 includes a display 118, a numeric pad 120, and a card reader 122. Processing device 114 is operatively connected to memory 116, as well as the components of user interface 112, such as display 118, numeric pad 120, and card reader 122. It should be understood that display 118 and numeric pad 120 may be replaced by a touchscreen in certain embodiments without departing from the scope of the present invention. It should also be understood that card reader 122 may be any suitable card reader, including a magnetic strip card reader, a smart card reader, a contactless card reader, or any combination thereof. User interface 112 may comprise other components operatively connected to processing device 114, such as cash or other payment-accepting devices, a barcode scanner, a radio frequency (“RF”) device reader, a receipt printer, and/or a camera, as should be understood in the art and as described in more detail below.

Processing device 114 may be a processor, microprocessor, controller, microcontroller, other appropriate circuitry, or any combination thereof. For example, multiple electronic devices including several microcontrollers configured to operate together within fuel dispenser 110 may be considered a “processing device.” Memory 116 may be any type of memory or computer-readable medium that is capable of being accessed by processing device 114. For instance, memory 116 may be random access memory (“RAM”), read-only memory (“ROM”), erasable programmable ROM (“EPROM”) or electrically EPROM (“EEPROM”), CD-ROM, DVD, or other optical disk storage, solid state drive (“SSD”), magnetic disk storage, including floppy or hard drives, any type of non-volatile memories, such as secure digital (“SD”), flash memory, memory stick, or any other medium that may be used to carry or store computer program code in the form of computer-executable programs, instructions, or data. Processing device 114 may also include a portion of memory accessible only to the processing device, commonly referred to as “cache.” Thus, memory 116 may be part of processing device 114, may be separate, or may be split between the relevant processing device and one or more separate memory devices.

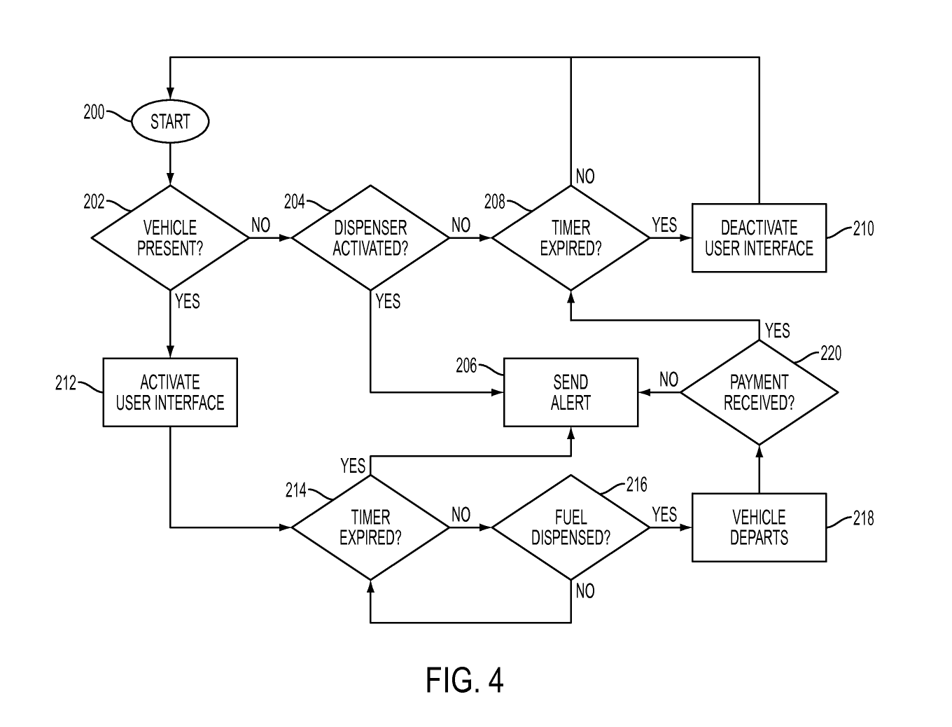

Memory 116 comprises computer-executable program code or instructions that, when executed by processing device 114, perform at least a portion of the processes described in more detail below with respect to FIG. 4. Memory 116 may also comprise one or more data structures for storing information, such as a database or a table. The computer-executable program code or instructions in this scenario, as should be known to those skilled in the art, usually include one or more application programs, other program modules, program data, firmware, and/or an operating system.

User interface 112 may be configured to facilitate the dispensing of fuel and the acceptance of payment for the dispensed fuel, as well as to provide other information to customers. For instance, display 118 is configured to provide instructions to a customer regarding the fueling process, while numeric pad 120 and card reader 122 are configured to accept payment card information provided by the customer. That is, card reader 122 is configured to receive payment card data from a magnetic strip card, such as a credit or debit card, that is swiped or inserted into the card reader. Numeric pad 120 is configured to receive information from a customer associated with the swiped card, such as a personal identification number (“PIN”) of a debit card or the billing zip code associated with a credit card.

If included within user interface 112, other devices are configured to facilitate financial transactions for payment of the dispensed fuel. For instance, the smart card reader is configured to handle transactions involving the use of smart cards, while the cash acceptor is configured to handle transactions involving cash payments. The receipt printer is configured to print a receipt upon completion of a fueling process. Processing device 114 is configured to handle the communication and processing of all data transmitted to and received from the components of fuel dispenser 110, as explained in more detail below.

As should also be understood by those of ordinary skill in the art, fuel dispenser 110 also includes various components configured to facilitate the delivery of fuel to a vehicle. For instance, fuel dispenser 110 additionally comprises a piping network 124 in fluid communication with at least one underground storage tank (“UST”), a meter 126, a pulser 128, a valve 130, at least one hose 132, and at least one nozzle 134. Processing device 114 may be operatively connected to one or more of these components, such as pulser 128 and valve 130, in order to control their operation and to manage the delivery of fuel by fuel dispenser 110.

In the presently-described embodiment, a sensor 136 operatively connected to processing device 114 is mounted to a front surface 138 of fuel dispenser 110. Sensor 136 is configured to transmit data to processing device 114 representative of when an object enters, occupies, and/or departs from an area 140 adjacent to fuel dispenser 110. For instance, sensor 136 may be configured to transmit data to the processing device when a vehicle is parked next to fuel dispenser 110 such that at least a portion of the vehicle occupies area 140. It should be understood that area 140 monitored by sensor 136 may be selected or defined so that it covers the area in which a customer is most likely to park a vehicle in order to utilize fuel dispenser 110. As a result, sensor 136 transmits data to processing device 114 in the event a vehicle is located adjacent the fuel dispenser.

In another embodiment, such as the one illustrated in FIG. 2B, sensor 136 is instead located within a canopy 139 of fuel dispenser 110. Sensor 136 operates in substantially the same manner as that described above with regard to FIG. 2A. That is, sensor 136 is configured to transmit data to processing device 114 when a vehicle occupies at least a portion of area 140. It should be understood that, depending on the particular device used as sensor 136, area 140 may exhibit a difference shape, size, and configuration than that illustrated in FIGS. 2A and 2B. Those of ordinary skill in the art should appreciate, however, that, regardless of the particular arrangement of area 140, the area is configured such that at least a portion thereof will be occupied when a vehicle is located adjacent fuel dispenser 110 to engage in a fueling transaction.

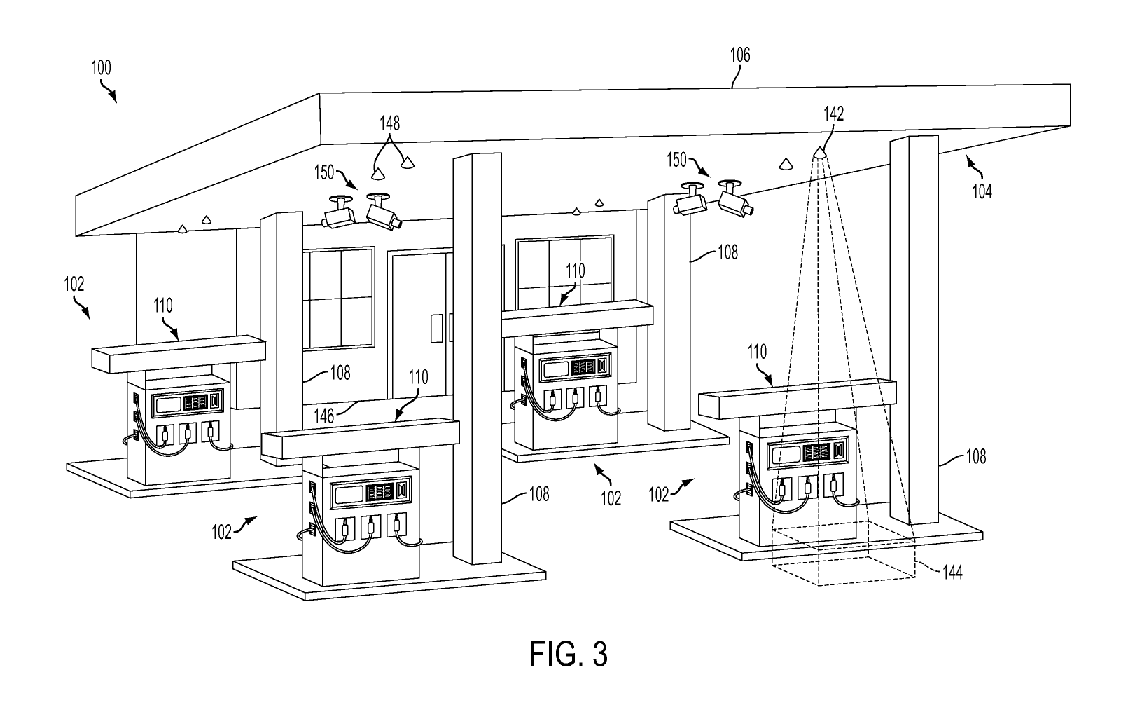

It should be understood that additional sensors may be installed in other locations of fueling environment 100 (FIG. 1) in order to detect the presence of a vehicle when located adjacent to a respective fuel dispenser 110. Referring to FIG. 3, for instance, another sensor 142 is mounted to the underside of canopy cover 106 instead of or in addition to sensor 136 (FIGS. 2A and 2B). In such an embodiment, sensor 142 is operatively connected to processing device 114 of the respective fuel dispenser. Sensor 142 is mounted to canopy cover 106 in a manner that allows the sensor to transmit data to the processing device representative of when an object enters, occupies, or departs an area 144 adjacent to respective fuel dispenser 110. For instance, a data line connecting sensor 142 to the processing device may be located within or attached to the adjacent canopy support 108. It should also be understood that the connections between the sensors and the processing device may be wireless.

Referring to FIGS. 1, 2A, 2B, and 3, sensors 136 and 142 are rangefinders in the presently-described embodiments. As should be understood in the art, a rangefinder is a device that measures distance from a location to a target and may be used to identify when an object enters, occupies, or departs the location or area. An example of a suitable rangefinder is the Devantech SRF04 Ranger ultrasonic rangefinder. It should be understood, however, that rangefinders utilizing technologies other than audio waves, such as laser rangefinders, may be employed without departing from the scope of the present invention. Additionally, sensors 136 and 142 may utilize other technologies suitable for determining the entrance, presence, and/or departure of an object from an area without departing from the scope of the present invention. For example, sensors 136 may be one or more photoeyes, while sensor 142 may be a light curtain. Such devices should be understood by those of ordinary skill in the art and are therefore not described in more detail.

Referring to FIGS. 1 and 3, fueling environment 100 may comprise additional components, devices, and structures, including a central facility, such as a convenience store 146. As should be understood, convenience store 146 may comprise additional computing devices, such as a point-of-sale device (“POS”), a site controller, and/or a manager's workstation. Those of ordinary skill in the art should appreciate that, in an embodiment that comprises these additional computing devices, they may be included within one computer or may be operatively interconnected via a local area network (“LAN”). Fuel dispensers 110 may be operatively connected to at least one of these devices via a two-wire current loop, such as an RS-422 or RS-485 data connection, as should also be understood in the art. Alternatively, fuel dispensers 110 may be operatively connected to one or more of the devices within the central facility via the LAN. Fuel dispensers 110 may also be operatively connected to a wide area network (“WAN”), such as the Internet, either directly or indirectly via one or more of these devices, the LAN, or another device. For instance, fuel dispensers may be operatively connected to the WAN via an enhanced dispenser hub as described in the Ser. No. 12/689,983 application referenced above. Accordingly, the devices within fueling environment 100, such as fuel dispensers 110, have access to resources external to the environment via the WAN.

Fueling environment 100 may comprise other devices, such as lights 148 and one or more security cameras 150 affixed to convenience store 146 or to the underside of canopy cover 106, as illustrated in FIGS. 1 and 3. In the present embodiment, processing device 114 of each fuel dispenser 110 is operatively connected to security cameras 150. This may be accomplished by a direct connection or via one or more additional components, such as the POS and/or site controller, in order to facilitate communication with the security cameras as described below. Preferably, each area adjacent to fuel dispensers 110 which a vehicle may occupy to refuel, such area 140 or 144, is monitored by a separate security camera. Alternatively, each security camera 150 may be directed at a single fueling island 102. In another embodiment, security cameras 150 may be configured to monitor the entire fueling environment by cycling through various areas of the environment.

FIG. 4 illustrates an exemplary process utilized by fueling environment 100 in accordance with an embodiment of the present invention. The ensuing description of the process illustrated in FIG. 4 is made with reference to the components described above with respect to FIGS. 1, 2A, 2B, and 3. The process begins at step 200, which may include any necessary tasks that are initiated by fueling environment 100. In one embodiment, for instance, each security camera 150 is activated at step 200 and begins recording video received by the respective camera. It should be understood that this may be accomplished by recording the video to conventional media, such as video tape. Preferably, however, security cameras 150 are configured to record to digital media and are operatively connected to an electronic storage facility that contains the media. The electronic storage facility may be located in the central facility of fueling environment 100, such as convenience store 146, or may be remotely located with respect to environment 100 and operatively connected thereto via the WAN. It should be understood that the electronic storage facility may be any suitable device from a simple universal serial bus (“USB”) external storage device attached to a simple computer to a complex server configured solely to handle storage of video footage.

Process flow proceeds to step 202, where processing device 114 determines whether a vehicle occupies an area adjacent to a fuel dispenser. For instance, sensor 132 or 142 transmits data to processing device 114 of the respective fuel dispenser 110, respectively, indicating that a vehicle has entered respective area 140 or 144. Alternatively, each sensor transmits data to the processing device when a vehicle is stationary within the applicable area for longer than a predetermined amount of time, indicating that the vehicle has been parked. It should be understood that the process illustrated in FIG. 4 may loop continuously so that processing device 114 repeatedly makes the determination of whether a vehicle occupies an area adjacent a fuel dispenser in order to proceed with the subsequent determinations explained below. Alternatively, process flow may pause at step 202 until the sensor transmits data to the processing device indicating that a vehicle has parked adjacent the fuel dispenser or upon the expiration of a timer, as described below.

If processing device 114 has not received a transmission from a sensor indicating the presence of a vehicle, process flow proceeds to step 204 where the processing device determines whether fuel dispenser 110 has been activated. If so, process flow proceeds to step 206 where processing device 114 outputs an alert. In this scenario, the alert indicates that the dispenser has been activated without a vehicle located adjacent the dispenser. In one embodiment, the alert may be an audible alert produced by a speaker operatively connected to processing device 114 and connected to fuel dispenser 110. Preferably, however, processing device 114 transmits data representative of the alert to a device associated with an individual within fueling environment 100 tasked with handling such alerts. For instance, processing device 114 transmits the data to the manager's workstation located inside convenience store 146 in order to alert the manager of fueling environment 100. In one embodiment, processing device 114 transmits the alert data to a mobile device associated with the fueling environment's operator or manager.

In one embodiment, processing device 114 retrieves from memory 116 the time that fuel dispenser 110 was activated and identifies the video footage stored in the electronic storage facility corresponding to both the time and the fuel dispenser. In one embodiment, the data transmitted by processing device 114 for the alert comprises the identification of the footage. Alternatively, processing device 114 retrieves the video footage and transmits it with the alert data. In such an embodiment, the recipient of the alert can review the video footage in order to determine whether additional steps should be taken. For example, if a customer dispenses fuel to a storage container in an authorized manner but has not parked his vehicle adjacent to fuel dispenser 110 in a manner that would activate the sensor, the manager may choose to ignore the alert. However, where the video footage reveals that a potential theft is in progress, the manager may choose to take additional actions. These may include deactivating fuel dispenser 110, issuing an audible alert at the dispenser, and/or alerting the local authorities.

If the manager decides to alert the authorities, he may do so electronically by transmitting data to a facility associated with the local authorities via the WAN. The data may include the video footage and information associated with fueling environment 100, such as its address. The facility may then transmit the alert including the video footage to officers in the vicinity of fueling environment 100. It should be appreciated that such action provides nearby officers with video footage of a crime in progress that includes a video of the culprit or his vehicle. This may facilitate apprehension of the criminal before completion of the criminal act or shortly thereafter.

Depending on how the alert is handled, step 206 may include additional actions. If payment is received for any fuel dispensed, for example, the manager may opt to dismiss the alert and erase the associated video footage in order to save electronic storage space. If the manager deactivated fuel dispenser 110 in response to the alert, he may be required to reset the dispenser before the process returns to step 200.

If processing device 114 determines at step 204 that fuel dispenser 110 has not been activated since the last check, process flow proceeds to step 208. At this step, processing device 114 determines the amount of time since fuel dispenser 110 was last activated or used. If the amount of time is greater than a predetermined amount, processing device 114 deactivates certain components of fuel dispenser 110 at step 210, such as user interface 112. In one embodiment, rather than deactivating the entire interface, processing device 114 may deactivate display 118 or instruct the display to deactivate the display's backlighting component in the case of a liquid crystal display. Process flow then returns to step 200 and proceeds in the manner described above. In other embodiments, processing device 114 may deactivate or reduce the power to other components of fueling environment 100, such as lights 148, as explained below.

It should be understood that processing device 114 may take in account other factors, such as the time of day, when determining whether components should be deactivated. For instance, processing device 114 may deactivate components of fuel dispenser, such as user interface 112, only during non-peak hours. Regardless, it should be appreciated that deactivating components when not in use extends the component's life, as well as reduces the amount of energy consumed by the device and fueling environment 100.

If processing device 114 determines that the amount of time that has passed since the last time fuel dispenser 110 was activated or used is not greater than a predetermined amount of time, process flow returns to step 200 and begins again. If processing device 114 receives data at step 202 indicating that a vehicle occupies an area adjacent fuel dispenser 110, such as area 140 or 144, process flow proceeds to step 212. At this step, processing device 114 ensures the components of user interface 112 are activated. That is, if any components, such as display 118, were previously deactivated, processing device 114 activates the components.

Processing device 114 may perform additional functions at step 212 as desired. For instance, processing device 114 may instruct the security camera 150 associated with the respective fuel dispenser 110 to zoom in and/or focus on area 140 in order to record video footage corresponding to the vehicle and the use of the fuel dispenser. In another embodiment, processing device 114 may instruct security cameras 150 to begin recording if any have previously been deactivated or have not yet been activated. In other embodiments, processing device 114 may activate or increase the power to other components that have been deactivated or to which power has been reduced. For example, processing device 114 may activate or increase the power to lights 148 in the event they had previously been deactivated or dimmed, such as at step 210.

In one embodiment, process flow proceeds from step 212 to step 214, where processing device 114 determines if the amount of time the vehicle has occupied area 140 or 144 is greater than a predetermined amount of time if no other action has occurred. That is, processing device 114 determines if a vehicle has been parked adjacent to the fuel dispenser without activating the dispenser and without moving. Such a scenario may indicate that fraud or theft is occurring. For instance, rather than engaging in a normal fueling process, the vehicle's owner may be attempting to deactivate or remove the fail-safes or security measures installed within fueling dispenser 110 in an attempt to receive fuel without paying for it. If a predetermined amount of time has expired without the user activating fuel dispenser 110, process flow proceeds to step 206 and proceeds in a manner similar to that described above.

If the predetermined amount of time has not expired, process flow proceeds to step 216, where processing device 114 determines whether fuel dispenser 110 is dispensing fuel. If not, process flow returns to step 214, and proceeds in the manner described above. If so, process flow proceeds to step 218 once the fuel has been dispensed to the vehicle. At step 218, the vehicle departs the space adjacent fuel dispenser 110 in which it is located. In one embodiment, this causes sensor 138 or 142 to transmit data to processing device 114 indicating the vehicle has departed. In another embodiment, the sensors cease to transmit data to the processing device indicative of the presence of a vehicle causing the processing device to determine the vehicle has departed.

At step 220, processing device 114 determines whether payment has been received for the fuel provided by fuel dispenser 110. It should be understood that the receipt of payment information and the handling of the payment transaction may be accomplished in any suitable manner known to those of ordinary skill in the art without departing from the scope of the present invention. If processing device 114 determines that payment was not received, process flow proceeds to step 206 and continues in a manner similar to that described above. This may include identifying and transmitting a relevant portion of video footage from security camera 150 in the manner described above. In an embodiment where processing device 114 instructed a specific one of video cameras 150 to zoom in and/or focus on the applicable area, the processing device may retrieve and transmit video from the specific camera at step 206.

On the other hand, if payment was received, process flow proceeds to step 208 and continues in a manner similar to that described above. For instance, processing device 114 may deactivate components of fuel dispenser 110, such as user interface 112, or cause the components to enter a “sleep” mode if a sufficient amount of time has passed since the fuel dispenser was used. As a result, the useful life of the components is extended and the power consumed by the same is reduced. As noted above, processing device 114 may determine whether to deactivate these components based on the time of day or other factors related to the use of fuel dispenser 110. Processing device 114 may also perform additional tasks at step 210. For instance, processing device 114 may delete the video footage stored by fueling environment 100 if the processing device determines that the footage is no longer needed in order to conserve electronic storage space.

In another embodiment, the sensors of fueling environment 100, such as sensors 136 and 142, are operatively connected to a centralized processing device (“CPD”), such as the POS or site controller described above. As a result, the CPD may take into account data received from all sensors and/or fuel dispensers when determining which components of fueling environment 100 to activate or deactivate. For example, if the predetermined amount of time checked at step 208 has passed for all sensors 136/142, the CPD may instruct user interfaces 112 for all fuel dispensers 110 to deactivate. The CPD may also instruct lights 148 and/or cameras 150 to power down or deactivate.

It should be understood that the CPD may be configured to communicate with fuel dispensers 110 via the LAN or in a conventional manner, such as the RS data connections mentioned above, in one embodiment. Those of ordinary skill in the art should appreciate that this allows the sensors described herein to be incorporated into legacy fueling environments without impacting the fuel dispensers. In such an embodiment, the sensors may be configured to communicate wirelessly with the CPD in order to avoid any changes to the physical structure of fueling environment 100.

It should also be appreciated that, in such an embodiment where sensors 136/142 are connected to a CPD, the CPD may deactivate the entire fuel dispenser 110 rather than just its components. This is because the sensors are connected to the CPD and do not rely on the relevant fuel dispenser for processing or power. As a result, the CPD may also be configured to reactivate each fuel dispenser based on data received from the sensor associated with the respective dispenser. For instance, because sensor 136 is operatively connected to the CPD, the sensor transmits data indicative that a vehicle is located adjacent to a respective fuel dispenser 110 to the CPD, which uses the data to activate the dispenser.

In one embodiment, the CPD can use the data received from the sensors to concurrently (re)activate multiple devices. For example, the CPD may receive data from a sensor indicative that a vehicle has entered fueling environment 100 and parked at fuel dispenser 110 associated with the sensor after the fueling environment's components have been powered down. In this case, the CPD may activate the dispenser, the dispenser's user interface, lights 148, and/or cameras 150 simultaneously at step 212. The process then proceeds to step 214 and continues in a manner similar to that described above.

It should be understood that the above description discloses a fueling environment that uses sensors, such as rangefinders, in an attempt to conserve the useful life of the environment's components, as well as reduce power consumed by the environment. The above description also discloses using the data transmitted by the sensors in an attempt to prevent fraud or theft.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

What is claimed is:

1. A retail environment comprising:
a retail device comprising a processing device and a user interface including at least one component operatively connected to the processing device; and
a sensor operatively connected to the processing device, wherein the sensor is configured to detect a presence of an object located adjacent the retail device and transmit data to the processing device representative of such detection,
wherein the processing device is configured to activate the at least one component based on data received from the sensor.

2. The retail device of claim 1 wherein the at least one component comprises a display.

3. The retail device of claim 1 wherein the at least one component comprises a wireless receiver.

4. The retail device of claim 1 wherein the at least one component comprises a card reader.

5. The retail device of claim 1 wherein the at least one component comprises a display and a card reader.

6. The retail device of claim 1 wherein the processing device is configured to deactivate the at least one component after a predetermined amount of time has passed without receiving data from the sensor.

7. The retail device of claim 1 wherein the retail device is a fuel dispenser, and the at least one component comprises a component configured to measure an amount of fuel provided by the fuel dispenser.

8. The retail device of claim 1 wherein the retail device comprises the sensor.

9. A retail environment that includes at least one retail device, the retail environment comprising:
a processing device;
a surveillance system operatively connected to the processing device; and
a sensor operatively connected to the processing device, the sensor being configured to detect a presence of an object located adjacent the retail device and transmit data to the processing device representative of such detection,
wherein the processing device is configured to transmit data to the surveillance system corresponding to the presence based on data received from the sensor.

10. The retail device of claim 9 wherein the surveillance system is configured to record the object based on the data received from the processing device.

11. The retail device of claim 10 wherein the processing device is configured to determine when the object is no longer adjacent the retail device based on transmissions from the sensor and transmit data to the surveillance system representative of such determination, and the surveillance system is configured to stop recording and save the recording of the object based on data received from the processing device.

12. The retail device of claim 9 wherein the retail device is a fuel dispenser comprising a plurality of components configured to facilitate dispensing fuel.

13. The retail device of claim 9 wherein the surveillance system comprises a camera.

14. The retail device of claim 13 wherein the camera is a video camera.

15. A retail environment comprising:
a retail device;
a processing device;
a component operatively connected to the processing device; and
a sensor operatively connected to the processing device, the sensor being configured to detect a presence of an object located adjacent the retail device and transmit data to the processing device representative of such detection,
wherein the processing device is configured to deactivate the component after a predetermined amount of time has passed without receiving data from the sensor.

16. The retail environment of claim 15 wherein the retail device comprises the processing device and the component.

17. The retail environment of claim 16 wherein the retail device comprises the sensor.

18. The retail environment of claim 15 wherein the component is a user interface.

19. The retail environment of claim 15 wherein the component is a display of a user interface.

20. The retail environment of claim 15 wherein the component comprises a plurality of lights of the retail environment.

21. The retail environment of claim 15 wherein the processing device is configured to reactive the component upon receipt of data from the sensor indicating the presence of the object.

22. The retail environment of claim 21 wherein the component comprises a plurality of lights of the retail environment.

23. A method for activating components of a retail environment that includes a retail device and a sensor configured to detect a presence of an object occupying at least a portion of an area adjacent the retail device, the method comprising the steps of:
receiving data from the sensor indicating the presence of the object; and
activating a component based on the data.

24. The method of claim 23 wherein the component comprises a camera and the method further comprises directing the camera to the portion of the area.

25. The method of claim 23 wherein the component comprises a display of the retail device.

26. The method of claim 23 comprising deactivating the component when the sensor does not detect the presence of the object for a predetermined amount of time.
